(19) United States
(12) Patent Application Publication
(10) Pub. No.: US 2013/0100168 A1
(43) Pub. Date: Apr. 25, 2013

(54) OVERDRIVE CONTROLLING SYSTEM FOR LIQUID CRYSTAL DISPLAY

(71) Applicants: Po-shen Lin, Shenzhen (CN); Liang-chan Liao, Shenzhen (CN); Gong Chen, Shenzhen (CN)

(72) Inventors: Po-shen Lin, Shenzhen (CN); Liang-chan Liao, Shenzhen (CN); Gong Chen, Shenzhen (CN)

(21) Appl. No.: 13/377,546

(22) PCT Filed: Oct. 25, 2011
(86) PCT No.: PCT/CN2011/081228

§ 371 Date: Dec. 10, 2011

(30) Foreign Application Priority Data
Oct. 19, 2011 (CN) 201120399522.5

(51) Int. Cl. G09G 5/00

(52) U.S. Cl. 345/660

(57) ABSTRACT

An overdrive controlling system for a liquid crystal device includes an image scaling device for storing a current frame data and a preceding frame data, and a time sequence controlling panel. The time sequence controlling panel includes an overdrive controller, a first storage device connected to the overdrive controller for storing a lookup table, and a time sequence controlling circuit connected to the overdrive controller. The time sequence controlling panel further includes two low-voltage differential signaling receivers respectively connected to the overdrive controller. The low-voltage differential signaling receivers are further connected to the image scaling device for receiving the current and preceding frame data and outputting the received frame data to the overdrive controller. The overdrive controller compares the current frame data and the preceding frame data with the lookup table to obtain a compensated image data, and outputs the compensated image data to the time sequence controlling circuit.

### BACKGROUND

1. Technical Field

The present disclosure relates to overdrive technologies, and particularly, to an overdrive controlling system for a liquid crystal display.

2. Description of Related Art

Nowadays, overdrive technologies are often applied in liquid crystal displays (LCDs) of large size for reducing gray-to-gray (GTG) response time and further for improving the display effect of moving images.

Referring to FIG. 2, a conventional overdrive controlling (OD) system includes an image scaling device 11 for scaling images displayed in the LCD, a low-voltage differential signaling receiver (LVDS receiver) 12 for transferring the scaled images, a first synchronous dynamic random access memory (SDRAM) 13 for storing a preceding frame data, an overdrive controller (ODC) 14 for controlling the operation of the overdriving process, an electrically erasable programmable read-only memory (EEPROM) 15 with a lookup table (LUT) stored therein, and a time sequence controlling circuit(T-con) 16. The image scaling device 11 includes a second SDRAM 110 for storing a current frame data. For illustrating purpose, in the FIG. 2, “RGB” represents current frame data, and “DE” (data enable) represents an address signal of LVDS, and “DCK” (data clock) represents a unit clock signal.

The working process of the conventional OD controlling system can be described as the followings:

In step 1, the image scaling device 11 transmits the current frame data of the present image displayed in the LCD panel to the ODC 14 via the LVDS receiver 12, and the format of the current frame data is LVDS.

In step 2, the ODC 14 reads the preceding frame data from the first SDRAM 13 and stores the current frame data output from the LVDS receiver 12 into the EEPROM 15, the ODC 14 further compares the preceding frame data with the current frame data via the LUT to obtain a compensated image data corresponding to the current frame data. Conventionally, the current frame data are compared with the preceding frame data by using an array of 7 rows*7 columns.

In Step 3, the ODC 14 outputs the compensated image data to the time sequence controlling circuit 16.

In the above OD controlling system, the first SDRAM 13 is essential for storing the current frame data and is connected to the ODC 14, and the second SDRAM 110 is also essential for storing the preceding frame data, which may result in a complicated configuration of the OD controlling system. Also, it takes time for the time sequence controlling circuit 16 to read the stored data from the first SDRAM 13.

### SUMMARY

In one embodiment of the present disclosure, an overdrive controlling system of a liquid crystal display includes an image scaling device and a time sequence controlling panel. The image scaling device is configured for storing a current frame data of a to-be-displayed image and a preceding frame data before the current frame data. The time sequence controlling panel includes an overdrive controller, a first storage device connected to the overdrive controller for storing a lookup table; and a time sequence controlling circuit connected to the overdrive controller. The time sequence controlling panel further includes two low-voltage differential signaling receivers respectively connected to the overdrive controller. The low-voltage differential signaling receivers are further connected to the image scaling device for receiving the current frame data and the preceding frame data and outputting the current frame data and the preceding frame data to the overdrive controller. The overdrive controller compares the current frame data and the preceding frame data with the lookup table to obtain a compensated image data corresponding to the current frame data, and outputs the compensated image data to the time sequence controlling circuit.

Preferably, the two low-voltage differential signaling receivers are respectively connected to the image scaling device via two low-voltage differential signaling interfaces.

Preferably, each one of the two low-voltage differential signaling receivers is connected to the overdrive controller via a data line, a synchronous signal line, a clock signal line.

Preferably, the first storage device is an electrically erasable programmable read-only memory.

Preferably, the image scaling device further comprises a second storage device for storing the current frame data and a preceding frame data.

Preferably, the second storage device is a synchronous dynamic random access memory.

With the two low-voltage differential signaling receivers, the image scaling device of the present disclosure is capable of outputting both the current frame data and the preceding frame data to the overdrive controller. That is, the current frame data and the preceding frame data can be output to the overdrive controller to be compensated with the omission of the second SDRAM in the conventional overdrive controlling system, which not only reduces the product cost but also improves the data processing efficiency since there is no need to read data from the omitted second SDRAM.

### DISCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a schematic view of an overdrive controlling system for a liquid crystal display in accordance with an embodiment of the present disclosure.

FIG. 2 is a schematic view showing a configuration of a conventional overdrive controlling system.

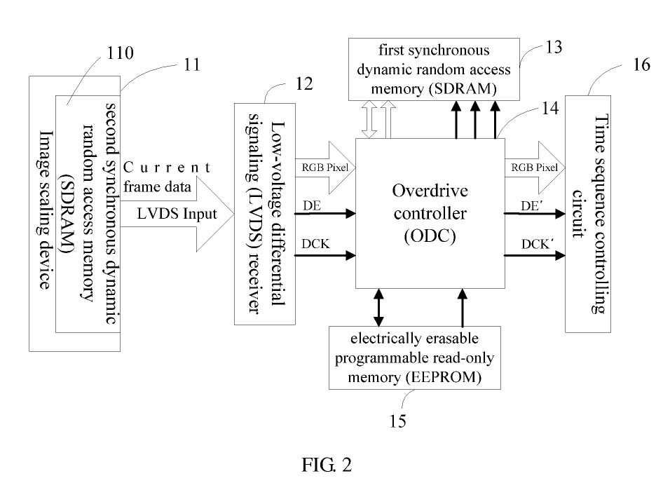

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

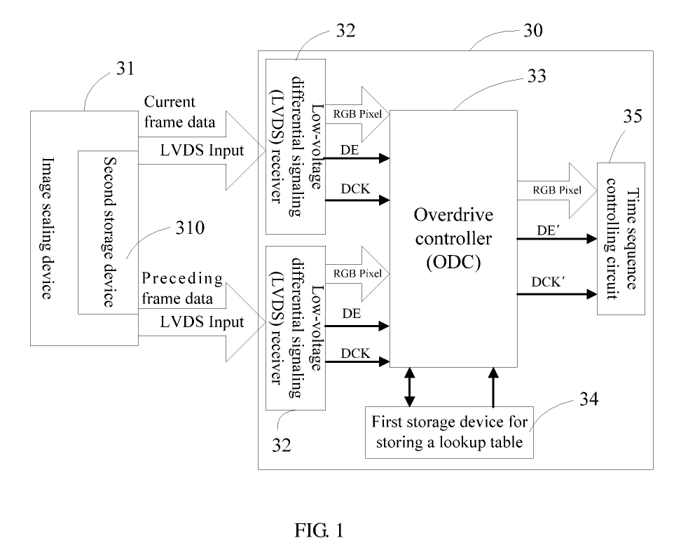

Referring to FIG. 1, an overdrive controlling system for a liquid crystal display (LCD) is provided. The overdrive controlling system includes a time sequence controlling panel 30 and an image scaling device 31. The image scaling device 31 is configured for storing the current frame data of a to-be-displayed image and a preceding frame data before the current frame data.

The time sequence controlling panel 30 includes two low-voltage differential signaling (LVDS) receivers 32 respectively connected to the image scaling device 31, an overdrive controller (ODC) 33, a first storage device 34 for storing a lookup table (LUT), and a time sequence controlling circuit 35. The first storage device 34 and the time sequence controlling circuit 35 are electrically connected to the ODC 33. In some embodiments, the first storage device 34 may be an electrically erasable programmable read-only memory (EEPROM). The two LVDS receivers 32 receive the current frame data and the preceding frame data from the image scaling device 31 and further output the current frame data and the preceding frame data to the ODC 33. The ODC 33 receives the current frame data and the preceding data, and compares the received frame data with the LUT to obtain a compensated image data corresponding to the current frame data. The ODC further outputs the compensated image data to the time sequence controlling circuit 35. For illustrating purpose, in FIG. 1, “RGB pixel” represents the current frame data and the preceding frame data, “DE” represents an address signal of the corresponding LVDS receiver 32, “DCK” represents an unit clock signal, and the data transferred between the image scaling device 31 and the LVDS receiver 32 is LVDS format.

In the working process, the image scaling device 31 at first scales the to-be-displayed image and then outputs the current frame data and preceding frame data. The two LVDS receiver 32 receive the scaled current frame data and the scaled preceding frame data, and further output the scaled current frame data and preceding frame data to the ODC 33. The ODC 33 receives the scaled current frame data and preceding frame data, reads the LUT from the first storage device 34 for obtaining the gray values of the two scaled frame data. In the ODC 33, the gray values of the current frame data and the preceding frame data are compared for obtaining an overdrive voltage which can be used for compensating the gray values of the current frame data. The compensated image data corresponding to the current frame data thus is obtained. The ODC 33 then outputs the compensated image data to the time sequence circuit 35 and converts the compensated image data to an electrical level signal to allow the to-be-displayed to be displayed in the LCD.

The image scaling device 31 in the embodiment further includes a second storage device 310 for storing a number of frame data of the to-be-displayed image. In some embodiments, the second storage device 310 may be a synchronous dynamic random access memory (SDRAM). A number of frame data of to-be-displayed, including the current frame data and the preceding frame data are stored in the second storage device 310. Specifically, the current frame data and the preceding frame data are stored in the second storage device 310. Before the two LVDS receivers 32 output the current frame data and the preceding frame data to the ODC 33, the image scaling device 31 outputs the current frame data and the preceding frame data stored in the second storage device 310 to the two LVDS receivers 32 respectively in one time period.

In the embodiment, the image scaling device 31 is connected to the two LVDS receivers 32 via two LVDS interfaces respectively. Each LVDS receiver 32 is connected to the ODC 33 via a data line for transmitting the frame data of the to-be-displayed image, an address signal line for transmitting the address signal of the corresponding LVDS receiver 32, a clock signal line for transmitting the unit clock signal, and a synchronous signal line for transmitting a synchronous signal for controlling the start and the end of the transmission of the frame data.

With the two LVDS receivers 32, the preceding frame data and the current frame data stored in the second storage device 310 of the image scaling device 31 can be output to the ODC 33 to be overdriven at the same time with the omission of the second SDRAM in the conventionally overdrive controlling system, which reduces the cost of the product and further improves the processing efficiency since there is no need to read data from the omitted SDRAM.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. An overdrive controlling system for a liquid crystal display, comprising:
an image scaling device for storing a current frame data of a to-be-displayed image and a preceding frame data before the current frame data; and
a time sequence controlling panel, comprising:
an overdrive controller;
a first storage device connected to the overdrive controller for storing a lookup table; and
a time sequence controlling circuit connected to the overdrive controller;
wherein the time sequence controlling panel further comprises two low-voltage differential signaling receivers respectively connected to the overdrive controller, the two low-voltage differential signaling receivers are further connected to the image scaling device respectively for receiving the current frame data and the preceding frame data and outputting the current frame data and the preceding frame data to the overdrive controller; the overdrive controller compares the current frame data and the preceding frame data with the lookup table to obtain a compensated image data corresponding to the current frame data, and outputs the compensated image data to the time sequence controlling circuit.

2. The overdrive controlling system as claimed in claim 1, wherein the two low-voltage differential signaling receivers are respectively connected to the image scaling device via two low-voltage differential signaling interfaces.

3. The overdrive controlling system as claimed in claim 1, wherein each one of the two low-voltage differential signaling receivers is connected to the overdrive controller via a data line, a synchronous signal line, a clock signal line.

4. The overdrive controlling system as claimed in claim 2, wherein each one of the two low-voltage differential signaling receivers is connected to the overdrive controller via a data line, a synchronous signal line, and a clock signal line.

5. The overdrive controlling system as claimed in claim 1, wherein the first storage device is an electrically erasable programmable read-only memory.

6. The overdrive controlling system as claimed in claim 2, wherein the first storage device is an electrically erasable programmable read-only memory.

7. The overdrive controlling system as claimed in claim 1, wherein the image scaling device further comprises a second storage device for storing the current frame data and a preceding frame data.

8. The overdrive controlling system as claimed in claim 2, wherein the image scaling device further comprises a second storage device for storing the current frame data and the preceding frame data.

9. The overdrive controlling system as claimed in claim 7, wherein the second storage device is a synchronous dynamic random access memory.

10. The overdrive controlling system as claimed in claim 8, wherein the second storage device is a synchronous dynamic random access memory.
